(19) United States
(12) Patent Application Publication
(10) Pub. No.: US 2007/0035764 A1
(43) Pub. Date: Feb. 15, 2007

(54) System and method for uploading files

(75) Inventors: William C. Aldrich, San Francisco, CA (US); Suzanne Ginsburg, San Francisco, CA (US); Jeffrey C. Stoddard, Burlingame, CA (US); Scott Hartley, Castro Valley, CA (US)

Correspondence Address: MORRISON & FOERSTER LLP, 755 PAGE MILL RD, PALO ALTO, CA, 94304-1018, US

(73) Assignee: Yahoo! Inc., Sunnyvale, CA (US)

(21) Appl. No.: 11/202,701

(22) Filed: Aug. 12, 2005

(51) Int. Cl. G06F 3/12

(52) U.S. Cl. 358/1.15; 358/403

(57) ABSTRACT

According to various aspects and examples described herein, systems and methods for uploading/transferring files are provided. In one aspect, an upload manager is provided, the upload manager for coordinating a transfer of an image file to a remote location. In one example, the upload manger includes logic for creating a reduced size image file associated with the image file, the reduced size image file having a smaller data size than the image file, initiating a transfer of the reduced size image file to the remote location, and initiating a transfer of the image file to the remote location subsequent to initiating the transfer of the reduced size image file. Transferring a reduced size image file (e.g., a thumbnailed version) may allow for relatively fast transfer and access times of the reduced size file compared to the full size version image file.

### BACKGROUND OF THE INVENTION

1. Field

The present invention relates generally to systems and methods for uploading files, and in one aspect to uploading/transferring image files in a more efficient manner.

2. Background

The process for uploading large files from a personal computer to an online storage account or for emailing to a recipient are often time consuming and frustrating. Most uploading scenarios involve the user having to wait until the transfer is complete before being able to undertake additional computing tasks. For example, once a user desiring to upload a large image file to an online storage location initiates the transfer, the user's PC will generally provide a message or status bar indicating that the transfer is in process. During this transfer, the PC's bandwidth and other computing resources may be largely consumed by the transfer. Attempting to multi-task on a typical PC while such a transfer is in progress, which is often not possible, may cause pronounced response lags.

As high resolution digital photography is more widely adopted, as well as other large-file-transfer applications, there will be an increased need to be able to transfer such large files in a timely and efficient manner so as to not reduce performance of the computer during the transfer of large files. Accordingly, there is a need for an improved system and method which overcomes one or more of the aforementioned drawbacks.

### BRIEF SUMMARY

According to various aspects and examples described herein, systems and methods for uploading/transferring files are provided. In one aspect, an upload manager is provided, the upload manager for coordinating a transfer of an image file to a remote location. In one example, the upload manger includes logic for creating a reduced size image file associated with an image file to be transferred (e.g., in response to a request to transfer the image file), the reduced size image file having a smaller data size than the image file. The upload manager further includes logic for initiating a transfer of the reduced size image file to a remote location, and initiating a transfer of the image file to the remote location subsequent to initiating the transfer of the reduced size image file.

The remote location may include a user computer, a server such as an online storage account or an email recipient. Additionally, the image file may be transferred from a user computer or server. Transferring a reduced size image file (e.g., a thumbnailed version) may allow for relatively fast transfer and access times of the reduced size file compared to the full size version image file. The full size version image file may be transferred when resources are substantially idol or at a slower rate, e.g., in the background.

According to another aspect, a method for transferring files is provided. In one example, the method includes receiving a request to transfer an image file to a remote location from a computer (e.g., a user computer or server) and creating a reduced size image file of the image file in response to the transfer request, the reduced size image file having a smaller data size than the image file. The method further includes initiating a transfer of the reduced size image file to the remote location, and initiating a transfer of the image file to the remote location subsequent to initiating the transfer of the reduced size image file.

According to another aspect, a computer readable medium encoded with computer readable program is provided. In one example, the computer readable medium includes program code for creating a reduced size image file of the image file in response to a transfer request, the reduced size image file having a smaller data size than the image file. The computer readable medium further includes program code for initiating a transfer of the reduced size image file to the remote location, and program code for initiating a transfer of the image file to the remote location subsequent to the transfer of the reduced size image file.

Other aspects, features, and techniques of the invention will be apparent to one skilled in the relevant art in view of the following detailed description of the invention.

### BRIEF DESCRIPTION OF THE DRAWINGS

FIG. 1 depicts one embodiment of a system level diagram showing the interconnectivity of one or more aspects of the invention;

FIG. 2 depicts one embodiment of a system level diagram of a computer system consistent with the principles of the invention;

FIG. 3A depicts a flow diagram for how a user may interact with one or more aspects of the invention, according to one embodiment;

FIGS. 3B-3D are screenshots showing various aspects of the invention, according to one or more embodiments;

FIG. 4A is a flow diagram depicting how electronic mail and image file selection may be more tightly integrated, according to one embodiment;

FIGS. 4B-4C are screenshots of various graphical user interface screens usable to implement one or more aspects of the invention;

FIGS. 5A-5G are various embodiments of graphical user interface screenshots illustrating one or more aspects of the invention;

FIG. 6 is one embodiment of a screenshot of a partially completed electronic mail message, consistent with the principles of the invention; and

FIG. 7 depicts a flow diagram of the operation of an upload manager for transferring files according to one example.

### DETAILED DESCRIPTION OF EXEMPLARY EMBODIMENTS

Various systems and methods for uploading files (e.g., image files) are disclosed. The following description is presented to enable a person of ordinary skill in the art to make and use the various examples. Descriptions of specific techniques and applications are provided only as examples. Various modifications to the examples described herein will be readily apparent to those of ordinary skill in the art, and the general principles defined herein may be applied to other examples and applications without departing from the spirit and scope of the inventions. Moreover, in the following description, numerous details are set forth for the purpose of explanation; however, one of ordinary skill in the art will recognize that certain aspects of the invention may be practiced without the use of these specific details. In other instances, well-known structures and devices are shown in block diagram form in order not to obscure the description of the invention with unnecessary detail. Thus, the appended claims are not intended to be limited to the examples described and shown herein, but are to be accorded the widest scope consistent with the principles and features disclosed herein.

One aspect described herein includes enabling a user to transfer a file from a user computer over a network without the user having to wait for the entire file to be uploaded (e.g., without consuming large portions of the computer resources at the time of the transfer). In one example, when a user requests to transfer a large file, such as a high resolution image file, an upload manager will coordinate the creation and transfer of a low resolution version (e.g., thumbnail size or reduced resolution full size image) of the image file rather than transferring the full high resolution version of the image file. Subsequent to the transfer of the reduce size image file version, for example, when the system is idle or system resource consumption is low, the upload manager initiates the transfer of the full sized version of the image file as requested. In one example, the delivery of the full high resolution image file may occur in the background without the sender's knowledge (e.g., without substantially impacting the performance of the user's computer).

The upload manager may include, for example, a software module stored as an application in any computer system (e.g., a user computer, server, etc.). In one example, the upload manager may be integrated with a computer system's operating system or may be bundled with any application program (e.g., web browser, email client, etc.). In another example, the upload manager may be included with a server and accessed through a web browser or the like. In addition, the upload manager may be deployed on any hardware platform (e.g., PC, mobile phone, PDA, etc.), and can link to numerous network services, such as an email server, web server, online photo storage server, music storage server, video storage server, etc.).

According to another aspect described herein, the methods and systems enable the uploaded/transferred reduced size image file version of the image file to be viewed before the upload manager has completed the transfer of the full version. By way of a non-limiting example, a user may request to upload a high resolution image file to an online storage account. Rather than waiting for the entire high resolution file to upload, a low resolution version of the file may be uploaded first, with the high resolution version being uploaded at a later time, e.g., when the user's system is relative idle. The low resolution version of the image, which will generally upload more quickly than the full size image due to its smaller size, may be available for viewing in a shorter time. Visitors to the online storage account will be able to view the image (which at this point is the low resolution version), without having to wait for the full high resolution image file to be uploaded.

In another example, a method for sending a high resolution image file attached to (or embedded in) an email is provided. Rather than send the high resolution image file initially, the upload manager initiates the transfer of a reduced size image file version, and subsequent to sending the reduce size image file, sends the high resolution image file to the recipient. Upon receipt of the email including the reduced size image file, the recipient may open and view the attachment, e.g., a thumbnail or low resolution version. In one example, the email recipient may receive another email message including the high resolution version, or indicate that the high resolution version is otherwise available to download, e.g., from an online location or the like.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed herein, a “computer” or “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. In addition, a “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

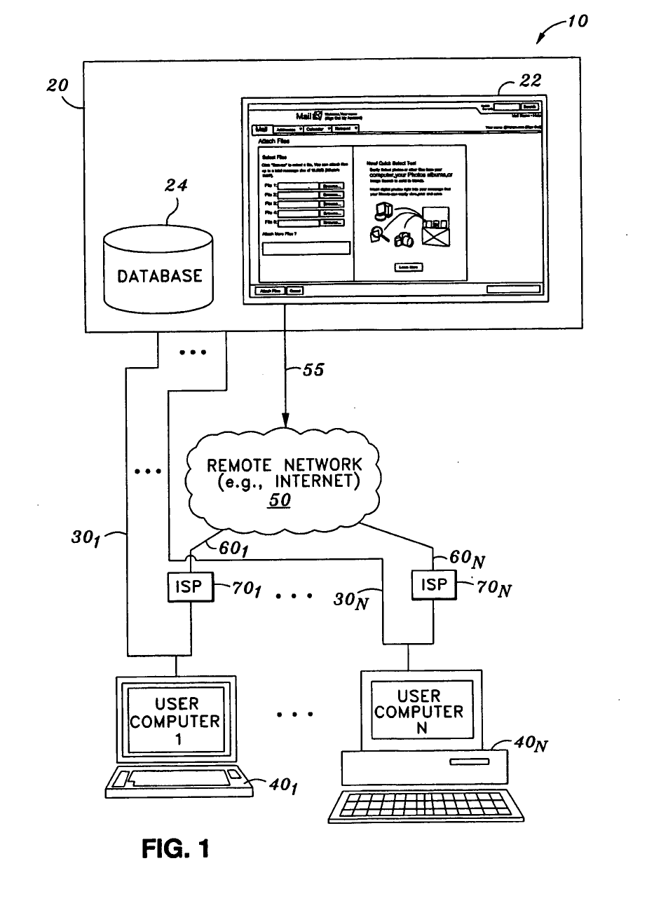

FIG. 1 shows a system block diagram of one embodiment of an information distribution system 10 in which the system and method of the invention may be used. In the embodiment of FIG. 1, system 10 comprises a remote server 20 that may be connected over one or more communications links 30₁-30_{N} (“30”) to one or more user computer systems 40₁-40_{N} (“40”). The remote server 20 may include computer readable instructions for generating and displaying one or target websites 22 to the user computers 40. In one embodiment, the remote server 20 may further include one or more databases 24 for storing data such as, for example, user data and/or target website 22 data. While for brevity remote server 20 is referred to in the singular, it should equally be appreciated that remote server 20 may be comprised of a plurality of individual computers or servers.

Remote server 20 may further be connected to a remote network 50 (e.g., the Internet) or a remote site (e.g., a satellite, which is not shown in FIG. 1) via communication link 55. The remote network 50 or remote site may be used to allow the remote server 20 to provide a wider variety of computer software, content, etc. to the one or more user computers 40. In addition, user computers 40 may be coupled to the remote network via communication link 60₁-60_{N} and internet service provider (ISP) 701-70_{N}.

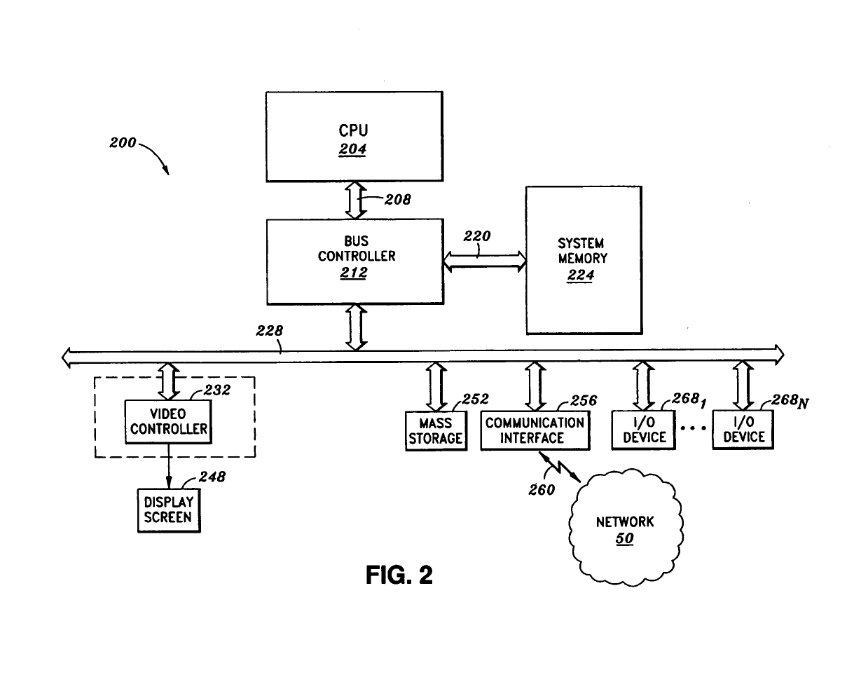

Referring to FIG. 2, depicted is one embodiment of the type of computer system which may comprise the one or more user computers 40 of FIG. 1. In particular, computer system 200 comprises a processor or a central processing unit (CPU) 204, which may include an arithmetic logic unit (ALU) for performing computations, a collection of registers for temporary storage of data and instructions, and a control unit for controlling operation for the system 200. In one embodiment, the CPU 234 includes any one of the x86, Pentium™ class microprocessors as marketed by Intel™. Corporation, microprocessors as marketed by AMD™, or the 6x86MX microprocessor as marketed by Cyrix™ Corp. In addition, any of a variety of other processors, including those from Sun Microsystems, MIPS, IBM, Motorola, NEC, Cyrix, AMD, Nexgen and others may be used for implementing CPU 204. Moreover, the CPU 204 is not limited to microprocessors but may take on other forms such as microcontrollers, digital signal processors, reduced instruction set computers (RISC), application specific integrated circuits, and the like. Although shown with one CPU 204, it should equally be appreciated that computer system 200 may alternatively include multiple processing units.

The CPU 204 is coupled to a bus controller 212 by way of a CPU bus 208. The bus controller 212 may include a memory controller integrated therein, although the memory controller may be external to the bus controller 212. In one embodiment, the system memory 224 may be coupled to the bus control 212 via a memory bus 220, where the system memory 224 may include synchronous dynamic random access memory (SDRAM). System memory 124 may optionally include any additional or alternative high speed memory device or memory circuitry. The bus controller 212 is coupled to a system bus 228 that may be a peripheral component interconnect (PCI) bus, Industry Standard Architecture (ISA) bus, etc. Coupled to the system bus 228 are a graphics controller, a graphics engine or a video controller 232, a mass storage device 252, a communication interface device 256, one or more input/output (I/O) devices 268₁-268_{N}. The video controller 232 may be coupled to a video memory and video BIOS, all of which may be integrated onto a single card or device. The video memory may be used to contain display data for displaying information on the display screen 248, and the video BIOS may include code and video services for controlling the video controller 232. In another embodiment, the video controller 232 may be coupled to the CPU 204 through an advanced graphics port (AGP) bus (not shown).

The mass storage device 252 may include (but not be limited to) a hard disk, floppy disk, CD-ROM, DVD-ROM, tape, high density floppy, high capacity removable media, low capacity removable media, solid state memory device, etc., and combinations thereof. The mass storage device 252 may further include any other mass storage medium. The communication interface device 256 may include a network card, a modem interface, etc. for accessing network 50 via communications link 260. The I/O devices 268₁-268_{N} include a keyboard, mouse, audio/sound card, printer, and the like. The I/O device 268₁-268_{N} may be a disk drive, such as a compact disk drive, a digital disk drive, a tape drive, a zip drive, a jazz drive, a digital video disk (DVD) drive, a solid state memory device, a magneto-optical disk drive, a high density floppy drive, a high capacity removable drive, a low capacity media device, and/or any combination thereof.

Computer system 200 may further include system firmware, such as system BIOS, for controlling, among other things, hardware devices in the computer system 200. The system firmware may include ROM and/or flash (or EEPROM) memory.

As is familiar to those skilled in the art, the computer system 200 may further includes an operating system (OS) and at least one application program, which in one embodiment, are loaded into system memory 224 from mass storage device 252. The OS may include any type of OS including, but not limited or restricted to, DOS, Windows, Unix, Linux, Xenix, etc. The operating system is a set of one or more programs which control the computer system's 200 operation and the allocation of resources. The application program is a set of one or more software programs that performs a task desired by the user.

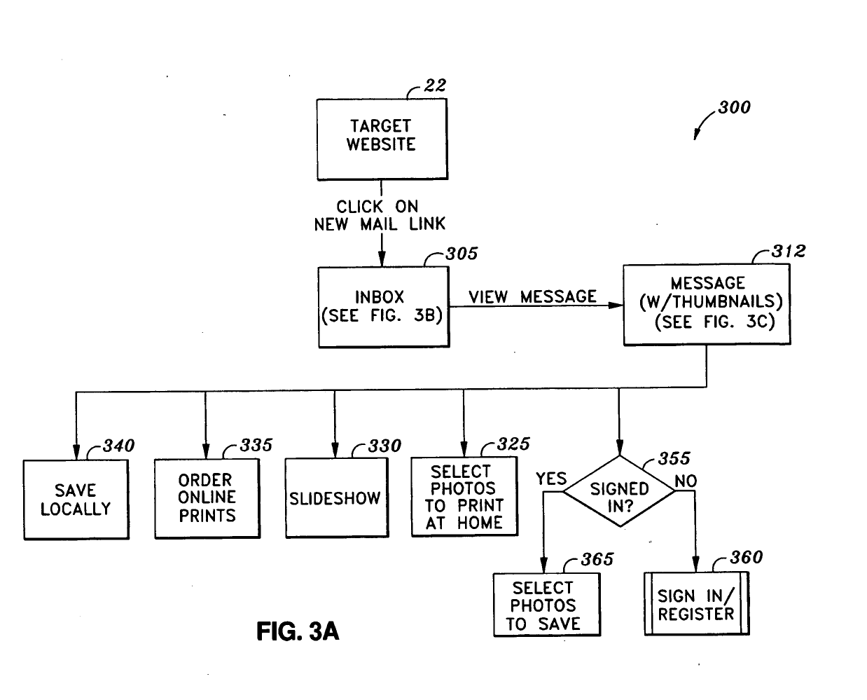

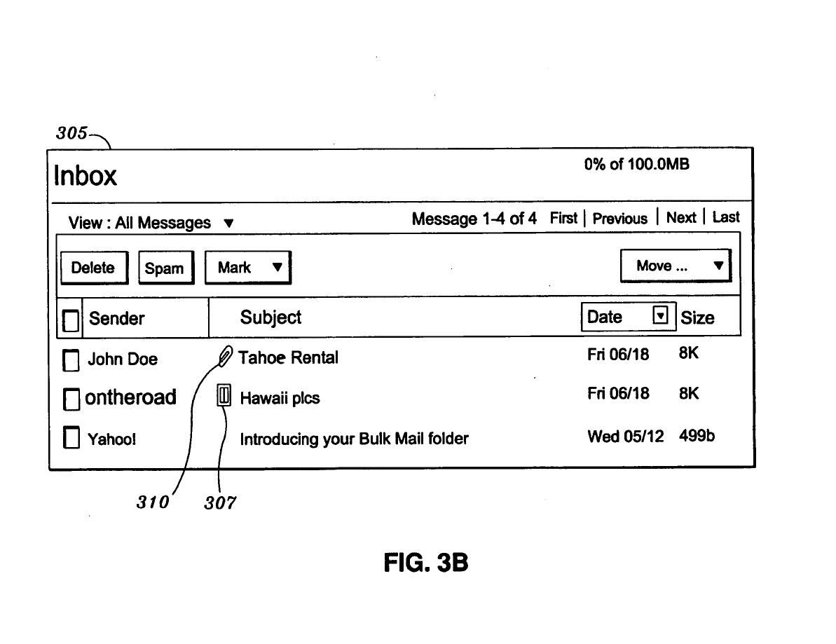

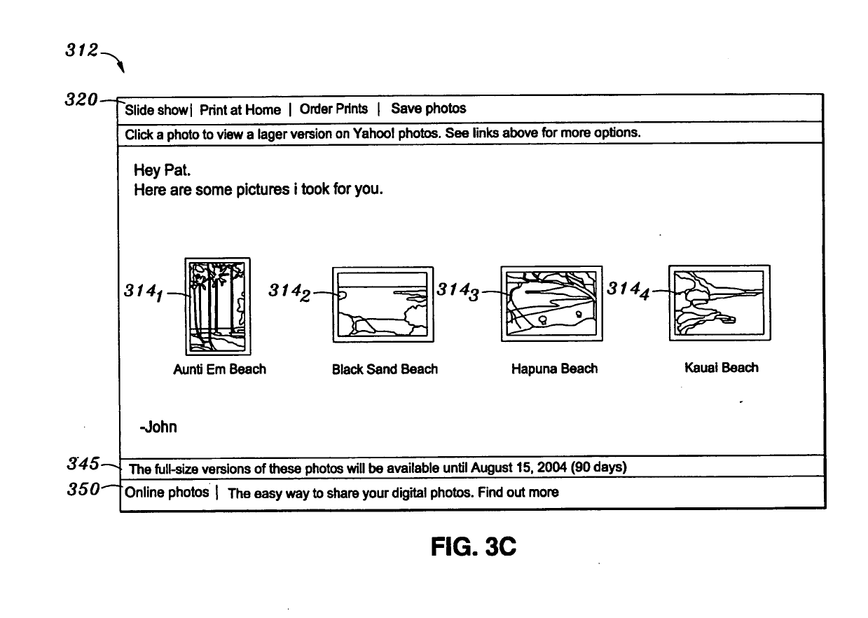

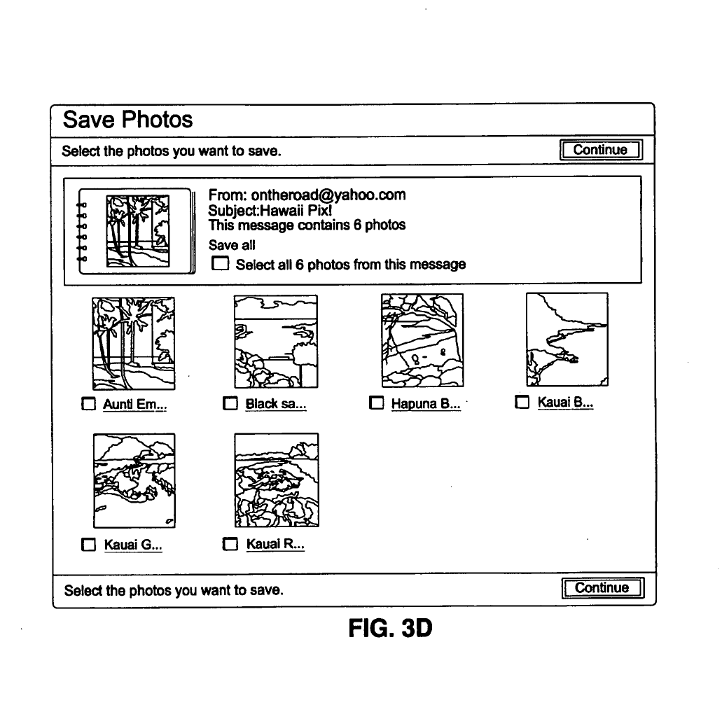

Referring now to FIG. 3A, depicted is a flow diagram for one example of how a user may receive and/or organize electronic mail containing image files, which may be used with various aspects described herein. In particular, process 300 begins with a user accessing target website 22. As previously described, a user computer 40 coupled to network 50 may be used to access the target website 22 from server 20. Thereafter, from target website 22 a user may then select a hypertext link to access their webmail inbox 305. It should be appreciated that the user may be prompted to log in to a corresponding user account prior to being able to access inbox 305. In another embodiment, target website 22 may include text or an icon indicating that the user has new mail in its electronic mail inbox 305. One embodiment of a screenshot for inbox 305 is shown as FIG. 3B. However, it should of course be appreciated that numerous other embodiments and configurations may be used for inbox 305.

As shown in FIG. 3B, electronic mail may be presented in a web browser in a list fashion arranged by sender, subject or date. If an email contains an embedded image attachment, the image file icon 307 may be displayed. If, on the other hand, an email contains a traditional file attachment, the typical attachment icon 310 may be displayed instead. Where an email contains both embedded and traditional attachments, either or both of the image file icon 307 and attachment icon 310 may similarly be displayed.

From inbox 305, once a user selects to view a particular email, process 300 of FIG. 3A may then open and display the contents of the chosen email message, such as message 312 of FIG. 3C. FIG. 3C depicts one embodiment of a screenshot of message 312, where the message contains embedded image thumbnails 314₁-314₄. In one example, the full image files which correspond to thumbnails 314₁-314₄ are not downloaded as part of message 312, but are rather maintained on server 20, or some other remote online account. In this embodiment, the thumbnail data and link information to the full image files are all that are downloaded to the user computer 40. For larger image files, this would decrease the amount of time required to download message 312, thereby improving the efficiency of image file sharing.

Message 312 may also contain an options menu 320. In particular, the options menu 320 includes options for printing the image files locally on a physical printer (325), for presenting the photos as a slideshow for online ordering of prints (330), for ordering online prints (335), and for locally saving the full image files (340). In one embodiment, the full image files may be downloaded and stored locally on user computer 40 by selecting the “save photos” option.

In addition to the options menu 320, message 312 may also contain additional information 345 relating to the image files. For example, in FIG. 3C information 345 indicates that availability of the full image files which correspond to thumbnails 314₁-314₄. Finally, message 312 may further include online options 350 for storing the full image files on, or otherwise making the image files accessible to, a remote server. In one embodiment, the remote location may be a specialized photo storage account, such as Yahoo! Photos®. Using such a storage account, users may be able to upload and share image files that were sent to them. For example, from Yahoo! Photos® a logged-in user may be able to view, download and/or print the uploaded image files.

Referring back to FIG. 3A, if a user selects the online storage option 350, process 300 may continue to block 355 where a determination is made as to whether the user is logged in to the online photo storage account (e.g., Yahoo! Photos®). If not, the user may be prompted to log in at block 360. Once the user is logged in, process 300 continues to block 365 where the user is then permitted to select the photos to save to their online photo storage account. FIG. 3D depicts a screenshot of one embodiment for how a user may select, directly from an email, which image files should be uploaded to their photo storage account. A save confirmation screen may then be presented to the user indicating that the selected photos were successfully uploaded. As described herein, in some examples, the image files may be uploaded by creating and transferring a reduced size image file (e.g., a thumbnail) and subsequently transferring the full size image file into their photo storage account.

In some examples, the user may also be presented with a variety of options as to how the uploaded photos should be organized. For example, a user may be prompted to create a virtual album containing photos having some common characteristic (e.g., same theme, trip, etc.).

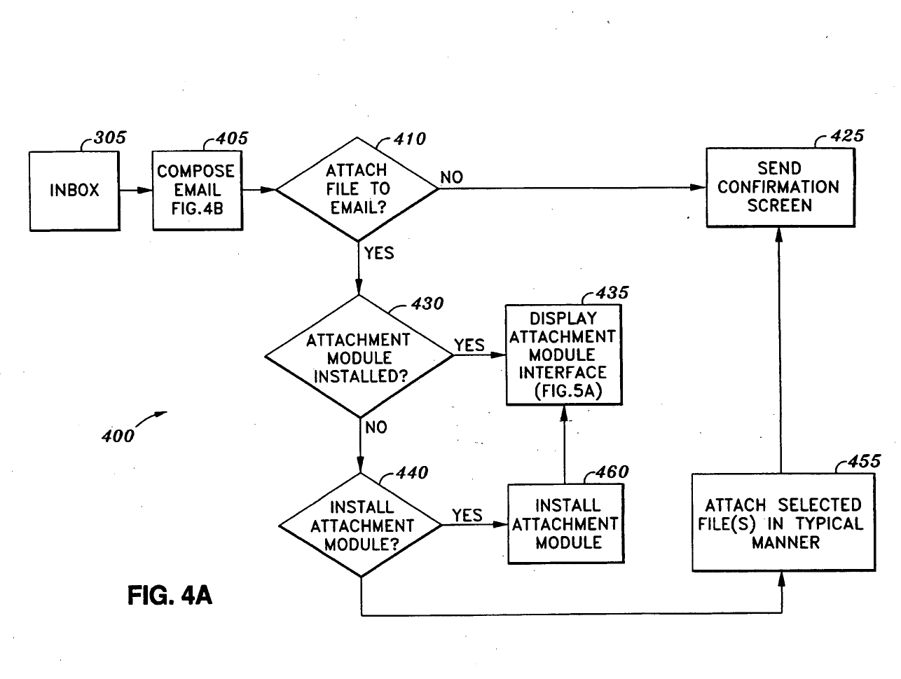

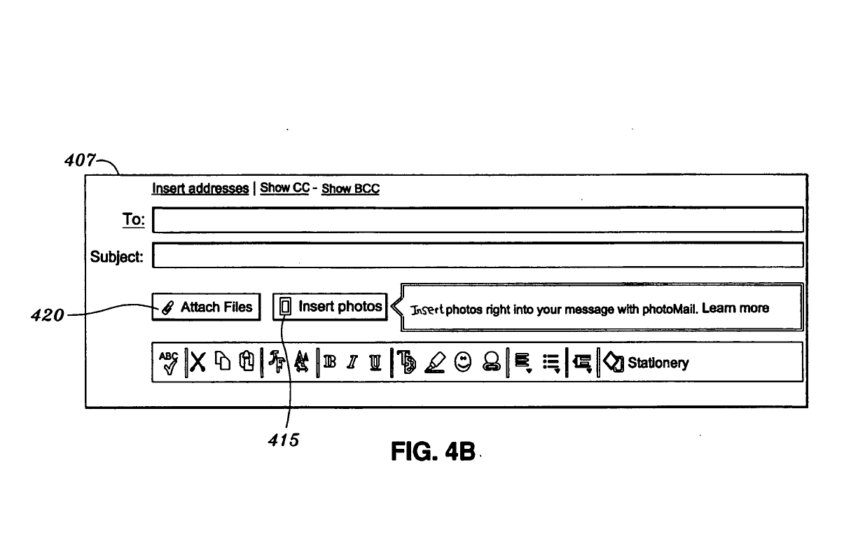

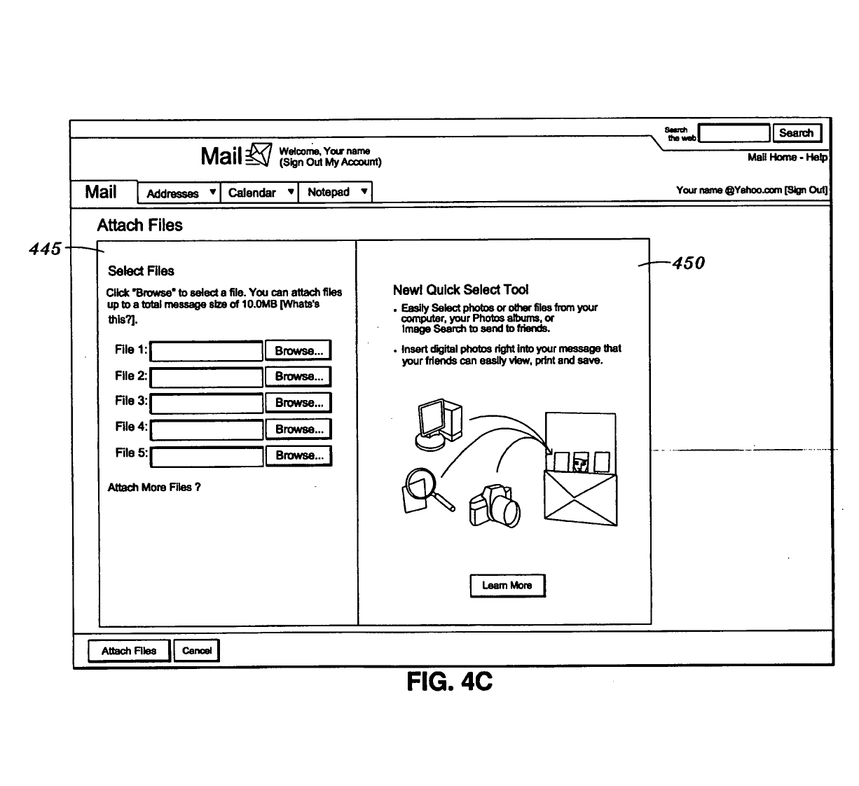

Referring now to FIG. 4A, depicted is a process 400 for how a user may select one or more image files to be included as part of an electronic mail message according to the various examples described herein, whereby a reduced size file is created and transferred prior to a full size image file. In addition to enabling a user to select and transfer image files from their user computer, a user may also access image files from a remote online account (e.g., Yahoo! Photos® or the like) or via an internet search to be embedded in an email message. Similar systems and methods are described, for example, in the following co-pending U.S. patent applications, both of which are co-filed on the same day herewith, the disclosures of which are hereby incorporated by reference in their entireties: patent application entitled, “SYSTEM AND METHOD FOR SELECTING AND MANAGING FILES”, having attorney docket no. 324212001000, and patent application entitled, “SYSTEM AND METHOD FOR SELECTING AND MANAGING FILES”, having attorney docket no. 324212001100.

Process 400 begins with a user accessing target website 22 (see, FIG. 1). As previously described, a user computer 40 coupled to network 50 may be used to access the target website 22 from server 20. Thereafter, from target website 22 a user may then select a hypertext link to access a webmail inbox, such as previously-described inbox 305. It should be appreciated that the user may be prompted to log in to a corresponding user account prior to being able to access inbox 305. In another embodiment, target website 22 may include a welcome screen with an icon dedicated to electronic mail functionality.

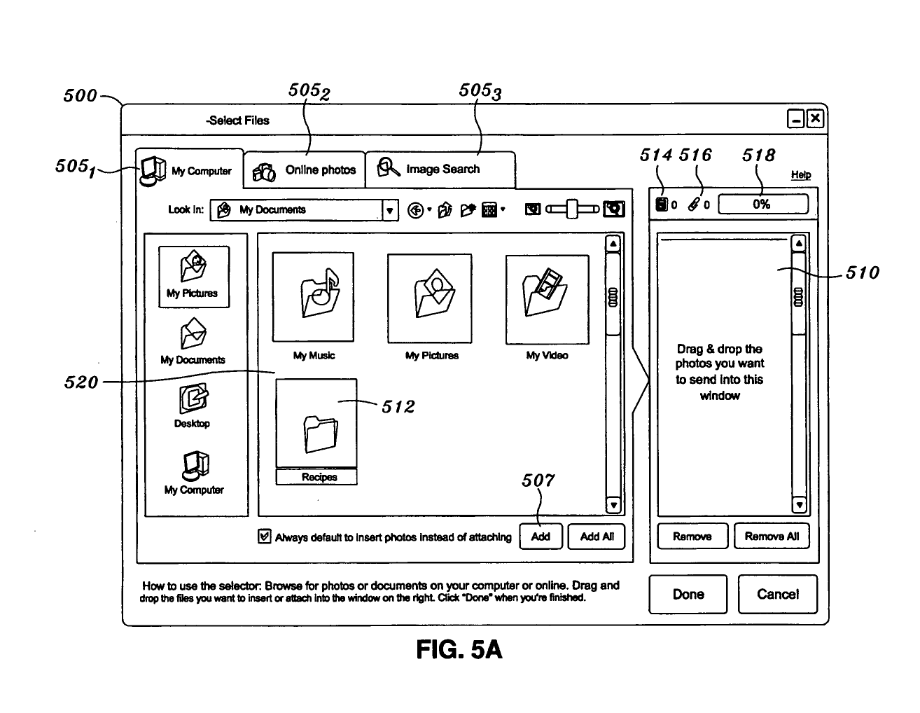

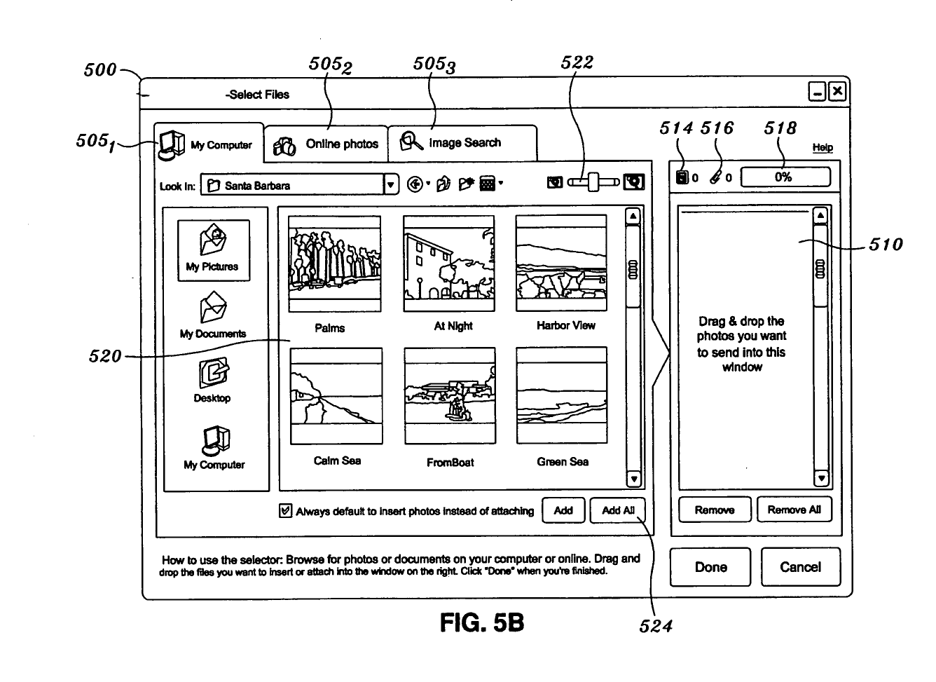

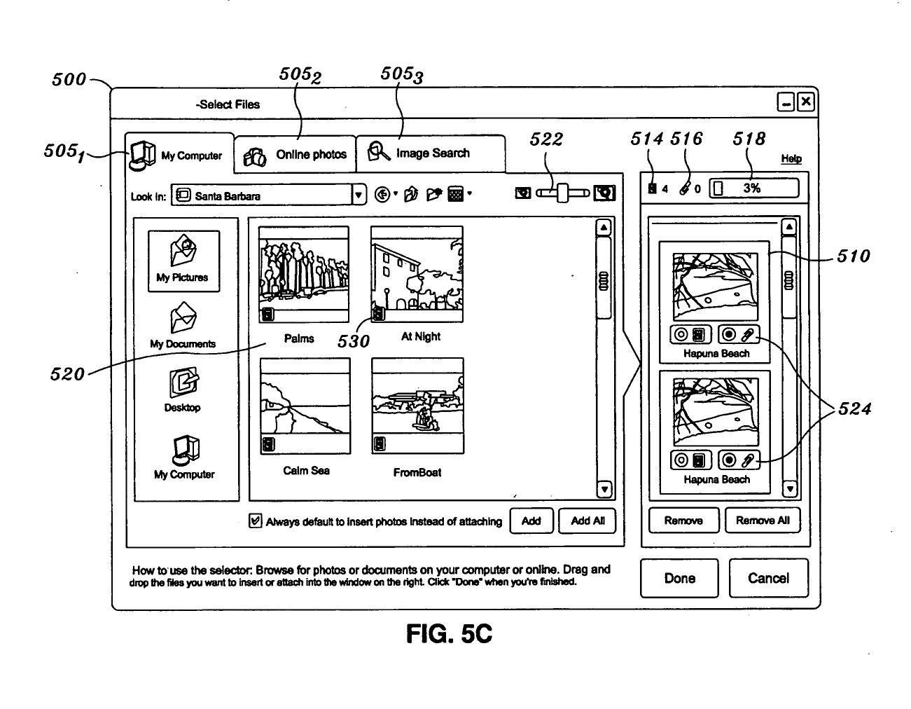

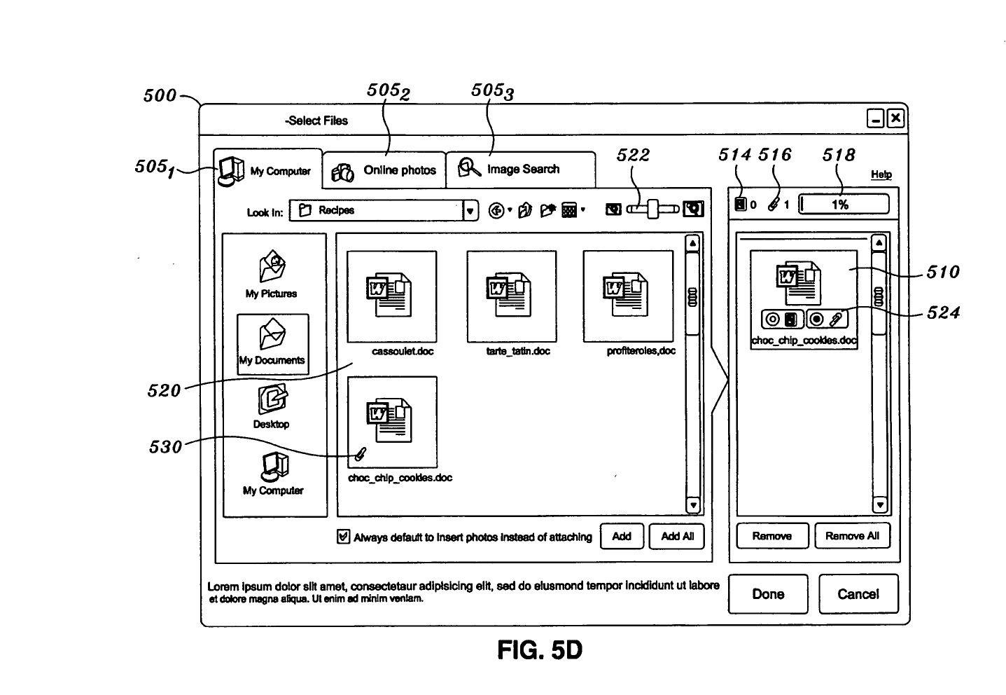

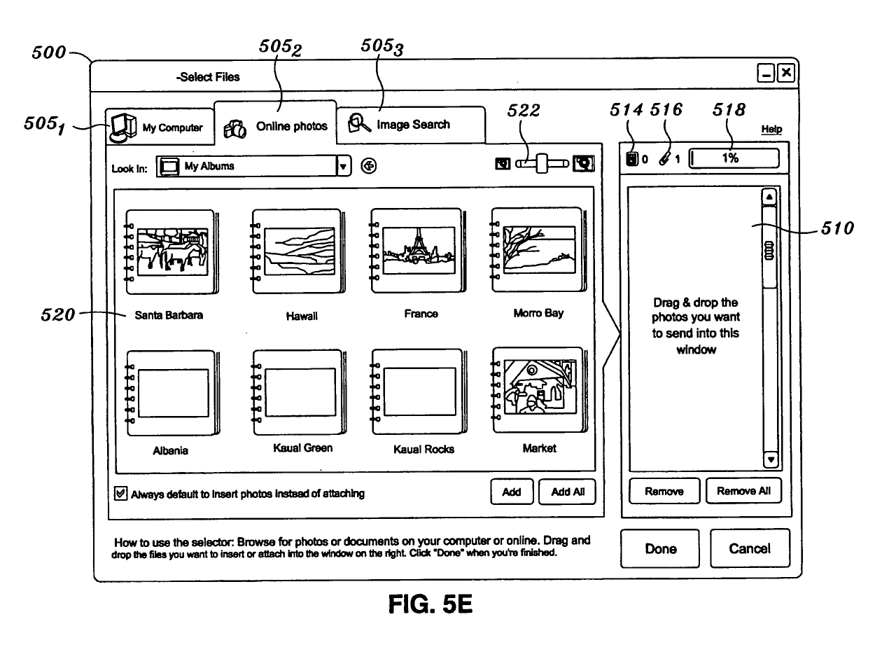

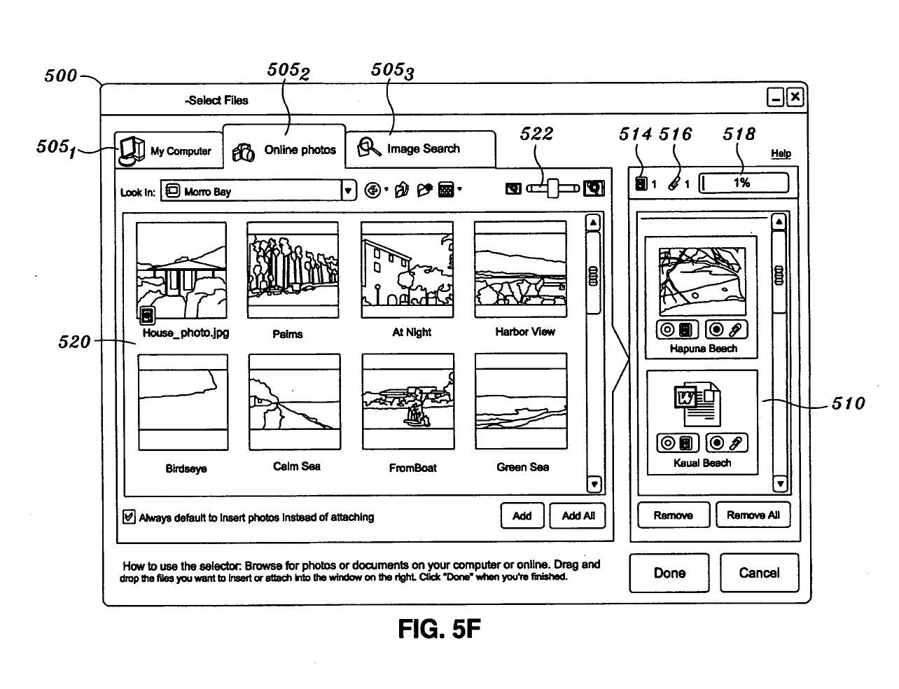

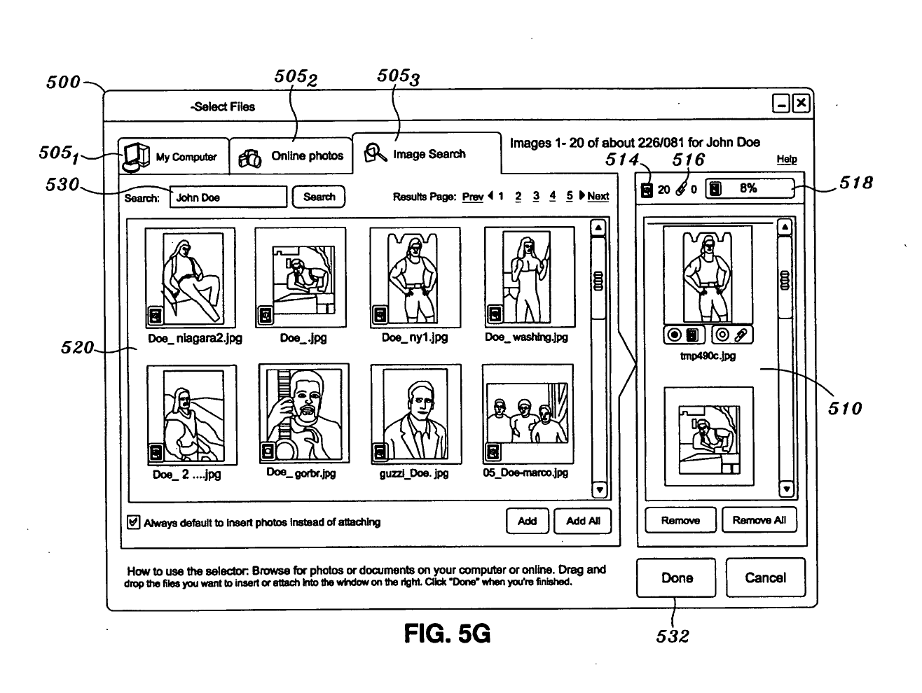

From the inbox 305, a user desiring to share one or more image files, would first select a “compose email” icon or menu option at block 405 to compose the email to which the one or more image files are to be associated. At this point, the user may compose an email in the typical fashion. FIG. 4B depicts one embodiment of a pop-up window usable to compose an email 407. If the user does not desire to attach or embed a file to the email 407, process 400 will simply continue to block 425 where, after the email 407 is sent, a delivery confirmation screen may be presented to the user. However, if the user does desire to attach an image file, one of icons 415 and 420 may be used to call up an attachment/embedding pop-up window. In one embodiment, icon 415 may be used to call up an interface for the photo embedding module discussed below with reference to FIG. 5A (e.g., graphical user interface 500 associated with an upload manager as described). As will be discussed in more detail below, icon 415 may be used to embed an image file into an email, wherein the upload manager as described herein operates to coordinate the creation of a reduced size image file for transfer and subsequent transfer of the full size image file. Icon 420, on the other hand, may be used to attach a non-image file, or any other file type that is stored on a user computer 40 using the traditional email attachment process. Alternatively, it should be understood that only one icon may be used for all attachment scenarios.

Once one of the attachment icons 415 or 420 has been selected by the user, a determination is made at block 430 as to whether the photo attachment module, including the upload manager, is installed on the user's computer (e.g., user computer 40). If so, the process 400 will continue to block 435 where, as discussed below, the attachment module's GUI 500 of FIG. 5A is displayed. If, on the other hand, the attachment module has not been installed on the user's computer, then process 400 will continue to decision block 440 where the user is prompted to install the attachment module. In one embodiment, the user may be presented with a typical file attachment dialog box, along with a prompt to install the photo attachment module. One such embodiment is depicted in FIG. 4C. In particular, section 445 of FIG. 4C enables the user to attach files in the typical fashion to the email 407 being composed (e.g., by browsing the computer's local hard drive). Section 450, on the other hand, prompts the user to learn more and/or install the attachment module. It should be appreciated that the pop-up dialog attachment window of FIG. 4C is but one embodiment and may have numerous other arrangements.

Referring back to FIG. 4A, if a user does not desire to install the attachment module, but rather attaches files in the typical fashion using section 445, for example, process 400 will continue to block 455 where the user-selected files are selected from a local storage location (e.g., local hard drive), and attached to the email 407. Once the email 407 is finished and sent, process 400 then terminates by presenting the user with a delivery confirmation screen at block 425. If, on the other hand, the user does desire to install the attachment module, then process 400 will proceed to block 460 where the installation process is commenced.

In one embodiment, the installation process comprises downloading and installing the photo attachment module in the form of Windows™ module and/or an ActiveX control module to the user's computer (e.g., user computer 40) over network 50. The Windows™ module may be used to generate the graphical user interfaces in a browser application, as described below with reference to FIGS. 5A-5G, while the ActiveX control module may be used to embed an ActiveX reference in an email to a remote online account. In one embodiment, this ActiveX reference is visually represented in an email as a thumbnailed image which corresponds to a full image file stored on a remote server. However, it should be appreciated that other operating system modules may similarly be used to generate the graphical user interfaces of FIGS. 5A-5G. In another embodiment, the attachment module may comprise a Firefox plugin, a Java program, or an XHTML component. As previously discussed, one aspect of the invention is to present the graphical user interfaces referenced above in a webmail environment using an Internet browser, such as Windows Internet Explorer™. A webmail account may then be used to compose an email message in a webmail environment without the use of an application program other than the browser itself.

FIGS. 5A-5G depict various Internet browser screenshots of a graphical user interface (GUI) 500 operable with an upload manger to attach and/or embed files into webmail correspondence. In one example, GUI 500 is operable with an upload manager to transfer an image file, wherein a reduced size image file (e.g., an image thumbnail and/or low resolution image file) is created and transferred initially. Subsequent to the reduced size image file, the full size image file is transferred. Additionally, as will be described in more detail below, GUI 500 may be operable to select image files from both local, as well as remote sources, for attaching or embedding into an email.

Referring now specifically to FIG. 5A, depicted is a screenshot of one embodiment of a graphical user interface 500 for a photo attachment module. In one embodiment, GUI 500 is generated by a Windows™ module executing on the user's computer (e.g., user computer 40). However, it should be appreciated that other operating system modules may similarly be used. In the embodiment of FIG. 5A, GUI 500 is presented in the standard Windows™ format with files being organized into tree-structured folders and subfolders. From GUI 500, a user may select an image file source by selecting one of tabs 505₁-505₃. One aspect of the invention is to provide a single interface which enables users to select image files from both local, as well as remote online account. To that end, when tab 505₁ is selected, display panel 520 of GUI 500 is populated with the tree-structured folders and files as stored on the user's local computer system (e.g., mass storage 252). The user may then drill down through the tree-structured arrangement to select image files to insert into the email in progress. In addition, and as will be described below, when tab 505₂ is selected, display panel 520 may be populated with image files available from a remote storage account (e.g., from a Yahoo! Photos®) account). Similarly, when tab 505₃ is selected, a search dialog box may be presented to the user for searching from available online third-party image sources (e.g., Internet picture search).

In one embodiment, a user may select a folder or file by clicking on it, and then selecting the ‘add’ button 507. This operation would move the selected file (or folder) to queue 510. For example, in the embodiment of FIG. 5A, folder 512 has been selected and may be added to queue 510 by simply clicking on the ‘add’ button 507. Alternatively, GUI 500 may be equipped with the drag-and-drop fuictionality allowing users to select and drag files/folders into queue 510.

As image files/folders are placed into queue 510, image file icon 514 and attachment icon 516 may be used to follow how many files, whether they be image files or otherwise, have been selected and placed in queue 510. In one embodiment, attachment icon 516 is used to keep track of the number of files that are placed in the queue 510 which are to be attached to the email (e.g., email 407) in the typical fashion. In another embodiment, or in addition to one or more of the previous embodiments, image file icon 514 may be used to track how many image files have been placed into the queue 510, which are to be embedded into the email. In addition, file size progress bar 518 may be used to keep track of the total storage space required for the selected files/folders. This may be useful, for example, where an email attachment size limit is being imposed.

Referring now to FIG. 5B, another embodiment of a screenshot for GUI 500 is depicted. In this embodiment, a user has drilled down the folder tree-structure to the file level. In particular, the contents of the folder named “Santa Barbara,” are presented in thumbnail view in display panel 520. Again, these are image files stored on a local storage device in a subfolder. A user may select one or more of these image files to attach to the email being composed (e.g., email 407) by either dragging and dropping them into queue 510, or using the previously-described ‘add’ button 507. Where no individual files have been selected, a user may place all of the files in the current folder into queue 510 by selecting the “add all” button 524. In another embodiment, slider 522 may be used to resize the thumbnailed images in display panel 520.

FIG. SC is yet another embodiment of a screenshot of GUI 500. In this embodiment, four image files have been placed into the queue 510 for embedding into an email (e.g., email 407). In addition to being able to scroll down through the queue 510, image file icon 514 also indicates that four image files are in the queue 510, while progress bar 518 indicates that only 3% of the allowable attachment size is being consumed by the four image files to be embedded in email 407, for example.

Continuing to refer to FIG. 5C, users may also be given the opportunity to individually select how each queued image file will be appended to the email in progress (e.g., email 407). For example, using radio buttons 524, users can toggle between having the image files attached to the email in the typical fashion (e.g., by selecting the paper clip radio button), or by embedding the image file and/or link information into the body of the email (e.g., by selecting the image file icon).

In the embodiment of FIG. 5C, as each file in the display pane 520 is added to the queue, the thumbnail is updated with an attachment state icon 530 to reflect this fact. For example, each of the four thumbnails of display panel 520 have been added to the queue 510 as embedded image files rather than as typical attachments. As such, those four thumbnails are depicted with the attachment state icon 530 for embedded image files.

FIG. 5D depicts yet another embodiment of a screenshot of GUI 500. In this embodiment, the user had drilled down into a subfolder called “Recipes” and has added a non-image file to the queue 510 for attachment to email 407. Since the file in the queue 510 is a non-image file, the paper clip radio button is automatically selected and the image file icon of the radio buttons 524 is inactive. Moreover, the thumbnail of the attached non-image file is updated with the appropriate attachment state icon 530 (i.e., the paper clip attachment icon).

Unlike with FIGS. 5A-5D, FIG. 5E is an embodiment of a screenshot of GUI 500 in which tab 505₂ has been selected. By simply selecting the “online photos” tab (i.e., tab 505₂), a user can access a remote online account as if it were a local directory. It should be appreciated that the user may have to log in to the remote account by providing a usemame and/or password. In another embodiment, cookies or another authentication mechanism may be used to automatically log the user into their account.

Once the user is properly logged in, display panel 520 may be populated with the contents of the remote storage account (e.g., Yahoo! Photos® account). It should be appreciated that the remote storage account may be any server that is accessible to the user's computer, either by communication link 30 or via network 50 (see, FIG. 1). Moreover, in the embodiment of FIG. 5E the available content used to populate the display panel 520 has been organized into “albums,” which function essentially the same as a tree-structured foldering system. By clicking on any of the albums in the display panel 520, the user would be able to access the individual image files contained therein. Even though the displayed albums and image files are not stored locally, a user need only drag-and-drop a desired file/album into the queue 510 to have the selected file/album embedded or attached to the email 407. In one embodiment, dragging-and dropping a file/album into the queue 510 while tab 505₂ is selected embeds a thumbnail of the image/album along with an ActiveX control reference to the online account. The recipient of the email may then view and/or download the full image file from the remote online account by clicking on the ActiveX reference.

FIG. 5F depicts a screenshot of another embodiment of GUI 500 in which the online photos tab is still selected (i.e., tab 505₂), and where the user has accessed the remotely stored album titled “Morro Bay.” As shown, the individual image files which comprise the Morro Bay album populate the display panel 520. From this point, the user may drag-and-drop any of the image files into the queue 510 to have them embedded or attached to the email 407. Once the image files are queued, the user may then use the radio buttons 524 to either attach the full sized image file to the email 407 in the traditional fashion, or embed the image file into the body of the email 407. In one embodiment, the full sized image may be embedded into the email and handled by the upload manager as described herein, wherein the upload manager may create a reduced size image file for immediate transfer and subsequently transfer the full size image file.

FIG. 5G depicts a screenshot of GUI 500 where a user has selected tab 505₃, which corresponds to image content that is available online (e.g., via network 50). After selecting tab 5053, a user may enter their search criteria into box.530. Based on the provided search criteria, an online search of available image files is performed, with the search results populating the display panel 520. As previously described, any of the individual search results may then be dragged into the queue 510 for eventual embedding or attaching to the email 407 being composed. Thus, as with locally stored image files (tab 505₁) and image files stored in a remote account (tab 505₂), image files posted on the Internet may all be accessed and integrated into electronic mail using a single interface (e.g., GUI 500).

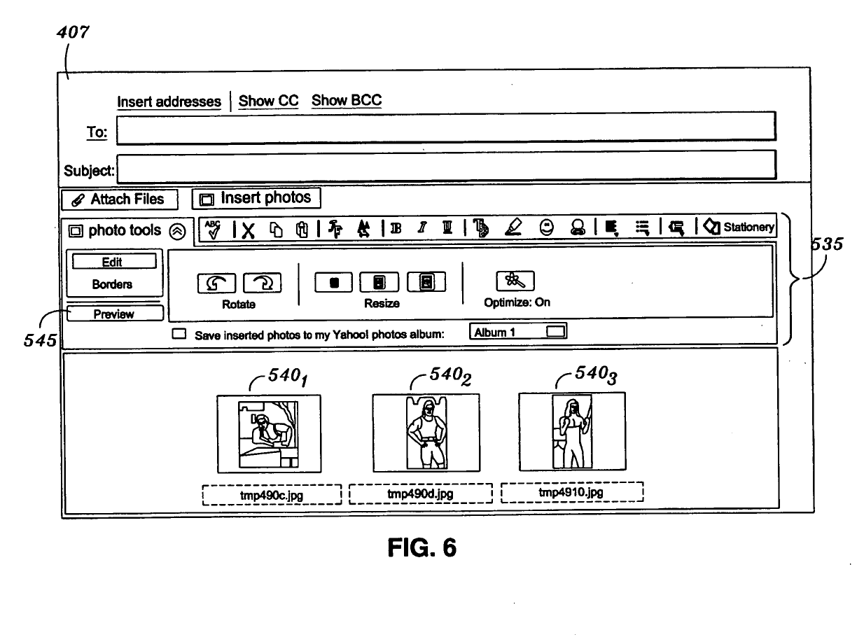

Once a user has completed the file attaching/embedding process, the user may exit the GUI 500 may clicking the ‘Done’ button 532. In one embodiment, this returns the user to the email 407 being composed. To that end, FIG. 6 depicts one embodiment of a screenshot of email 407 after three images (540₁-540₃) have been embedded. In some examples, once one or more image files have been embedded (or selected for embedding) into an email, a user may be presented with photo tools 535 for editing the photos before sending them. In addition, depending on the source of the thumbnailed images 540₁-540₃, a user may be given options for saving the image files either to a local storage medium (e.g., mass storage 252), or to a remote photo storage account (e.g., Yahoo! Photos®)). In addition to being able to edit and/or save the embedded images, preview button 545 may be used to preview the email (including the embedded images) prior to sending.

It will be recognized that a user may similarly select image files for uploading to a remote photo storage account. For example, a user may be presented with a GUI similar to GUI 500 and having functionality to select image files for uploading similar to that described for attaching/embedding with an email.

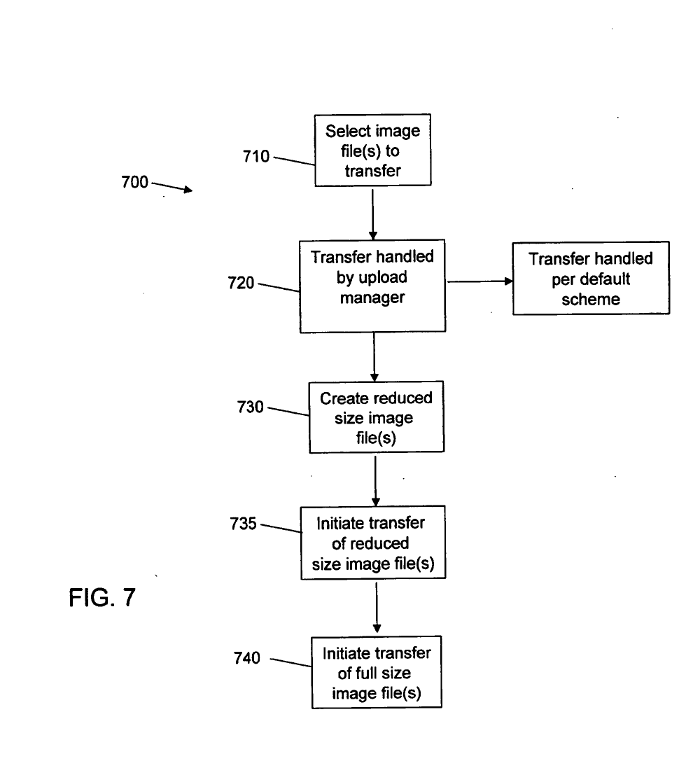

With reference to FIG. 7, the upload manager 700 will now be described in greater detail. As discussed above, one aspect of the invention includes decoupling user interaction from the act of sending a large data file (such as a high resolution image file) to a remote source (e.g., an email recipient, online data storage site, or the like). To that end, FIG. 7 depicts one embodiment of a process for transferring image files. In particular, process 700 begins with a user selecting one or more files in block 710 to upload/transfer to a remote location such as a remote storage account or email recipient. While in one embodiment, the files may be selected using GUI 500 as described with regard to FIGS. 5A-5G, it should be understood that a typical file attachment dialog box or other suitable interface may similarly be used.

Once the file(s) to be uploaded have been selected, process 700 continues to block 720 where the upload manager determines if and how the upload manager should handle the transfer. In one embodiment, the upload process of block 720 involves an initial determination as to whether the selected file(s) are sufficiently large that their upload should be handled by the upload manager as described herein. Various factors may be used to determine whether the upload manager should handle the file transfer, including, e.g., the file size, the total attachment/upload size, computer resources available at the time of transfer, or the like. In another example, all file uploads identified as image files, regardless of the size etc., are handled by the upload manager.

In the case where selected file(s) for uploading are image files and otherwise satisfy criteria for handling by the upload manager, the upload manager creates (or initiates the creation of) a reduced size version (i.e., reduced data size) of the image file in block 730, e.g., a thumbnail version and/or reduced resolution version of the selected image file. In one example, the reduce size file are significantly smaller sized files, e.g., less than 50% of the original file size, in another example less that 25% of the original file size, and in another example less than 10% of the original size file size. In one example, a thumbnail version from 2 Kbytes to 50 Kbytes is created.

Thereafter, rather than consuming system resources by attempting to upload the full version of the image files, process 700 initiates the upload of the reduced size image files in block 735. In one embodiment, this enables, for example, thumbnail versions of the full size images to be viewed by an email recipient faster than might be possible if the full size image files where attached to the email in the case where the selected file(s) are being emailed, or to be viewed by an online guest when such selected file(s) are being uploaded to an online storage account. In one embodiment, the user uploading the thumbnail versions will be provided with a delivery confirmation once the thumbnail versions have been successfully uploaded.

Process 700 continues to block 740 where the full versions of the selected file(s) are placed in a queue to be uploaded subsequent to the upload of the reduced version file. In one example, they are uploaded at a point in time when the system is idle. Alternatively, the selected file(s) may be queued until system resource consumption is low, e.g., below a preset threshold. In yet other examples, the system may be set to upload the full size files at a preset time (e.g., everyday at 2am) when resource consumption is expected to be low, or other trigger(s) such as when the user attempts to log off or shutdown (at which time the files might be uploaded prior to the log off or shutdown operation). In another embodiment, the uploading of the selected file(s) occurs in the background and without notification to the user, and may further commence simultaneously with the reduce size file transfer.

Accordingly, subsequent to sending the reduced file size version, the full version of the selected image file(s) are uploaded and transferred per the particular upload scheme. In the case of an upload to an online storage account, the selected file(s) may replace the previously uploaded thumbnailed versions. In the case of transferring the selected file(s) as an attachment to an email, the full version of the uploaded files may be transferred as a separate email from the previously uploaded thumbnailed versions, or alternatively, may replace the previously delivered email which had the thumbnailed versions attached.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Additionally, particular examples have been discussed and how these examples are thought to be advantageous or address certain disadvantages in related art. This discussion is not meant, however, to restrict the various examples to methods and/or systems that actually address or solve the disadvantages.

What is claimed is:

1. An upload manager for coordinating a transfer of an image file, the upload manager comprising logic for:
initiating the creation of a reduced size image file associated with the image file, the reduced size image file having a smaller data size than the image file;
initiating a transfer of the reduced size image file to a remote location; and
initiating a transfer of the image file to the remote location such that the image file is transferred subsequent to the reduced size image file.

2. The upload manager of claim 1, wherein the upload manager is a software module included with one or more of an operating system or an application program operating on a computer.

3. The upload manager of claim 1, wherein the upload manager is at least partially included with a server operable to communicate with a user computer.

4. The upload manager of claim 3, wherein the server includes one of an email server, an online photo storage server, a music storage server, and a video storage server.

5. The upload manager of claim 1, wherein the remote location includes a server, and the reduced size image file is replaced with the image file on the server once the image file has been transferred.

6. The upload manager of claim 1, wherein the upload manager is included with a hardware platform of a computer.

7. The upload manager of claim 1, wherein the image file comprises a photo or video file.

8. The upload manager of claim 1, wherein the reduced size image file comprises a thumbnail version of the image file.

9. The upload manager of claim 1, further comprising logic to place the image file in a queue for transfer subsequent to the transfer of the reduced size image file.

10. The upload manager of claim 1, wherein the initiation of the transfer of the image file is triggered when a computer associated with the location of the image file is substantially idle.

11. A method for transferring files, comprising:
receiving a request to transfer an image file to a remote location;
creating a reduced size image file of the image file in response to the transfer request, the reduced size image file having a smaller data size than the image file;
initiating a transfer of the reduced size image file to the remote location; and
initiating a transfer of the image file to the remote location such that the image file is transferred subsequent to the reduced size image file.

12. The method of claim 11, wherein the reduced size image file includes a thumbnail version of the image file.

13. The method of claim 11, wherein the image file is placed in a queue for transfer subsequent to the transfer of the reduced size image file.

14. The method of claim 11, wherein the image file comprises a photo or video file.

15. The method of claim 11, wherein the remote location includes an online location, the online location including one of an online photo storage server, a music storage server, and a video storage server.

16. The method of claim 11, wherein the initiating the transfer of the image file further comprises replacing the reduced size image file with the image file at the remote location.

17. The method of claim 11, wherein the transfer request includes a request to attach the image file to an email message, and wherein initiating the transfer of the reduced size image file comprises transferring the reduced size image file from the user computer as an attachment to the email message.

18. The method of claim 11, wherein the initiating the transfer of the image file comprises transferring the image file to the remote location when a computer associated with the image file is substantially idle.

19. A computer readable medium encoded with computer readable program code, the computer readable medium comprising:
program code for creating a reduced size image file of the image file in response to a transfer request of the image file, the reduced size image file having a smaller data size than the image file;
program code for initiating a transfer of the reduced size image file to the remote location; and
program code for initiating a transfer of the image file to the remote location subsequent to the transfer of the reduced size image file.

20. The computer readable medium of claim 19, wherein the reduced size image file includes a thumbnail version of the image file.

21. The computer readable medium of claim 19, further comprising program code for placing the image file in a queue for transfer to the remote location subsequent to the transfer of the reduced size image file.

22. The computer readable medium of claim 19, wherein the remote location comprises an online storage location, the online storage location comprising one of an email server, online photo storage server, a music storage server, and a video storage server.

23. The computer readable medium of claim 22, wherein the reduced size image file is replaced with the image file on the online storage location once the image file has been transferred.

24. The computer readable medium of claim 22, wherein the transfer request is a request to attach the image file to an email message, and wherein the reduced size image file is transferred from the user computer to the online storage location as an attachment to the email message.

25. The computer readable medium of claim 19, wherein the image file is transferred when a computer associated with the image file location or transfer request is substantially idle.
